(19) United States
(12) Patent Application Publication
(10) Pub. No.: US 2012/0045278 A1
(43) Pub. Date: Feb. 23, 2012

(54) Method for forming a mortise and tenon for tool free joinder, and joint assembled therefrom

(76) Inventor: Frank W. Schooley, Matlacha, FL (US)

(21) Appl. No.: 12/806,773

(22) Filed: Aug. 21, 2010

(51) Int. Cl. F16B 12/10; B27F 1/00

(52) U.S. Cl. 403/381; 144/371

(57) ABSTRACT

A method for making two items and their joinder, one having a mortise and the other a tenon to enable a substantially flush, contiguous, void-free abutment. All cuts are made with a straight router bit having a diameter “Y” from a single sheet of substrate stock having a thickness “X” such that Y≦(½)X. In the mortise, corners are given a rounding defined by Y and a length “L₁”. The tenon has a width substantially equal to L₁ and a height “Z”, such that Z>2X. On the item having the tenon, at each of the two opposing locations defined by the intersection of the tenon with the shoulder of the item from which the tenon is cut (and also defining a shoulder line from shoulder to shoulder), an additional undercut is given at a minimal, linear displacement sufficient to enable, upon joinder, the mated surfaces of the two items to appear in flush, contiguous, void-free abutment with minimal reduction in the strength of the join. The tenon further has a substantially rectangular peg-receiving aperture set at distance substantially equal to X from the shoulder line, and having a height “H”, such that H=X. A locking peg has a cross-section substantially conforming with the peg-receiving aperture. Rounding of the peg proximate to the undercuts is made with a rounder at a radial rounding substantially equal to (½)Y. The product of the method is also shown.

### FIELD OF THE INVENTION

The instant invention relates to the field of joinery of the surfaces of two items in secure, flush abutment for woodworking, masonry and metal-working building applications, and more specifically to mortise and tenon joints and methods for forming just joints and the assemblies resulting therefrom, formed in a manner that minimizes scrap without the use of multiple cutting tools, provides a basis for kitting a building application as a kit of parts, and enables simple on-site assembly into final functional construction without requiring an array of on-site tooling.

### BACKGROUND OF THE INVENTION

Joining the surfaces of two items in secure flush abutment has specific application and need in woodworking, masonry, metal working, and other fields. In searching for a method of forming joints from the materials to be joined themselves, and in determining a reliable, repeatable joint design that will permit easy and rapid assembly under a multiplicity of circumstances that would require the same and without the necessity of employing one or more standard assembling tools, the instant invention has emerged successfully in design and development and overcomes the deficiencies observed within the prior art and commercial context, as discussed hereinbelow and by implication of the teachings contained herein.

The joint of choice herein specified is a mortise and tenon. By way of background a mortise is formed on a first item and a tenon on the second such that when the mortise and tenon are joined, the surfaces of the items mount in secure abutment. By definition, a mortise is an aperture or slot cut into any type of material or stock, in this case in a first item intended to be joined to a second. A tenon is a projection, typically on one end of any type of material or stock, which is inserted into a mortise and, in this instance is formed on the second item. The height and width of the tenon is typically less than the height and width of the stock in which the tenon is disposed. When the tenon is inserted into the mortise, a mortise and tenon joint is thereby formed. Mortise and tenon joints, having a myriad of known configurations, are renowned to be some of the strongest joints known, and are employed in the making of many different assemblies, typically furniture-based.

Conventional mortise and tenon joints incorporate a mortise which mates exactly with the tenon. In other words, the tenon fills the mortise completely, leaving no gaps or space between the mortise and tenon once the tenon is inserted into the mortise. Creating a tenon that fits intimately within a mortise typically involves reducing the size of the tenon so that the tenon is the same size as the mortise in which the tenon is inserted.

The mortise and tenon are typically disposed such that the tenon forms a 90 degree angle with respect to the mortise in which the tenon is inserted. It is known in the art that forming a joint in which the angle defined by the mated surfaces is orthogonal is desired for strength, and typically complies with the ultimate assembly being created, which generally has orthogonal surfaces (as in furniture applications). However, if one seeks to mate surfaces together that define an angle other than orthogonal, the shoulder of the mortise may be beveled to define an angled surface that conforms to the angle of the tenon once inserted, and thereupon provides such angled configuration. Whether the mortise and tenon are at a 90 degree angle with respect to one another, or any other angle, once the tenon is inserted into the mortise, the resulting mortise and tenon joint can be further secured, depending upon the ultimate application of the joint, by fastening one member to the other using bolts, nails, wedges or other fasteners.

Mortise and tenon joints may also be secured using a conventional dovetail joint. Such mortise and tenon joints may be secured (or locked into place) using a dovetail joint in which one or more pins extend from the end of one member, and interlock with one or more tails cut into the end of a separate member, thus joining the two members more securely upon application of the pin. See, for example, U.S. Pat. No. 187,962 to Cantrell; and U.S. Pat. No. 3,591,212 to Rhyne. As such, mortise and tenon joints may be secured (or locked into place) using a dovetail aperture or slot across a tenon and a wedge of similar dovetail cross-section such that the dovetail cross-section is contained within the dovetail aperture when the tenon is inserted into the mortise. In other words, when the tenon is inserted into the mortise, the wedge is moved along the dovetail aperture until firm engagement therein, thereby locking the two members together and preventing separation until the wedge is removed. See, for example, U.S. Pat. No. 4,492,489 to Kantorowich and U.S. Pat. No. 4,867,598 to Winter IV. Also known in the art are mortise and tenon dovetail joints which, in accordance with the specifications of their ultimate application, avoid a protrusion of the tenon beyond the mortise (eliminating pinning) by incorporating a tenon which is shorter than the width of the material in which the mortise is cut (sometimes referred to as a stub tenon). See, for example, U.S. Pat. No. 1,093,023 to Alta; and U.S. Pat. No. 2,614,302 to Johnson.

Mortise and tenon joints may also be secured through means other than a dovetail joint. For example, a mortise and tenon joint in which one item sought to be mated to another has two mortises and the other has two tenon, permits locking the two together by first inserting the tenons into the mortises and then rotating the surfaces against one another. U.S. Pat. No. 3,009,719 to Otto, et al. Alternatively, a mortise and tenon joint may include a self-locking plate on each of the two members to be attached so as to secure the mortise and tenon joint after the tenon is inserted into the mortise. U.S. Pat. No. 4,797,020 to Winston. Further, a mortise and tenon joint may be fastened after the tenon is inserted into the mortise by a locking means, such as a pin or dowel which extends through each of the two members to be attached, which fastens the two members. U.S. Pat. No. 4,916,881 to Gilliand; U.S. Pat. No. 6,272,796 to Metzler.

The art further shows that mortises and tenons are cut from the base materials using a variety of tools, including both hand tools and power tools. For example, a tenon can be made using a hand saw or with a radial arm saw or table saw with a tenoning jig; while a mortise may be cut using a router, drill press, or mortising machine.

Certain construction projects may indifferently adopt a plurality of items comprised of different base materials that require joinder. Where the two items to be joined to one another are comprised of different base materials, typically such materials have different physical characteristics, like thickness, size, hardness, and specific density. Since mortise and tenon joints provide significant strength to the assembly post-joinder, such joints are sought, and thus, in this instance, are formed from different base materials. Notably, in such instances, a goodly amount of material is sacrificed in the forming of the mortise and tenon, arising as a result of having cut the joining items, and hence the respective mortise and tenon, from such different materials. Observably, it is a goal of the instant invention to minimize the waste of base materials, while maximizing the strength of the resultant construction assembly, by employing a single, sturdy base material for construction projects, provided in raw form in large rectilinear sheets for ease in cutting elements intended to be employed in the final assembled construction. By requiring the use of such materials, identity in physical characteristics between mortise and tenon is preserved, and by cutting from a single sheet, maximal use of the base material with minimal waste is also achieved.

It is therefore an object of the instant invention to provide a mortise and tenon joint in which all components of that joint are formed from the same base materials having the same characteristics, and minimizing waste of materials in the creation of construction projects, from houses to furniture, that are kilted pre-assembly and post-manufacture, cut from single, rectilinear sheets of identical materials, and employing identical mortise and tenon joinder techniques, thereby ensuring ease of manufacture, limiting the extent of scrap material, and providing all mortise and tenon elements to share the same composition and hence the same physical characteristics and sturdy implementation.

Another problem associated with construction projects that require the joinder of differing materials—in comparison to a single material—is that inherent in the differing materials selected is, per force the risk of different physical characteristics, which require the use of different tools, cutting rates and cutting materials to conform mortise, on one item of one type of material, to tenon, on another item of another type of material. It is thus a further object of the instant invention to provide a kit of parts cut from the same base material in various configurations for assembly, but all using the same mortise and tenon design for joining the parts. Preferably, the parts—with the simultaneous formation of the mortise and tenon joinder elements—are cut using a Computer Numerical Controlled Router (CNC Router) or similar device using a rotary cutting tool, and preferably using the same bit. In this manner, a further object of the instant invention is achieved: a single, rectilinear sheet of material is cut in accordance with a predetermined pattern with a CNC Router to provide a kit of parts for assembly into a final construction, all employing the same mortise and tenon, all cut with the same bit, and together reducing waste in materials, equipment and time.

Inasmuch as an object of the instant invention is to employ a router with a single bit in the cutting of a multiplicity of elements from a single sheet of substrate material to be assembled in accordance with a predetermined pattern, and a further object is the joinder of each of such elements through the use of identical mortise and tenon elements also formed in accordance with the pattern, it is important to understand the inherent problem implicated. By way of background, router bits create rounded, inside corners in the substrate. As one progressively reduces the size of the bit, the perception of approaching an actual orthogonal corner may be increased, but as the bit size is reduced, so, too, is the amount of material cut. Moreover, changing bit size also reduces turn-around time. Thus, to optimize production, one would look to the largest bit for the job, and then need to address the inability to have orthogonal cornering. On the other hand, in order for two elements to mate in flush manner, the corners of the tenon and mortise are generally squared (orthogonal) to one another. Accordingly, it is a further object of the instant invention to provide a mortise and tenon cut by way of a single router bit, such that upon assembly of the joint, the elements mate in a flush manner.

Other objects of the instant invention will be observable through a complete study of the specification, drawings and claims herein. Objects of the instant invention are provided as examples and are not intended to be limitive of the scope of the protection herein.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The present invention comprises a method and the product of the method. The method is intended to cut items which connect by way of a unique mortise and tenon, via a router having a single bit, with the items cut from one or more sheets of substrate stock, in accordance with predetermined patterns that optimize the use of the stock and reduce any waste.

An essential element of the method is the joinder between two items, which comprises a mortise on one and a tenon on the other, cut with the same router bit at the same time the item is cut from the substrate. The mortise and tenon are cut in accordance with the method herein such that upon assembly, they together form what appears to be a substantially flush, contiguous, void-free abutment resembling the sharpness of a mortise and tenon joint created using typical square cuts but, in fact, created by way of a single router bit. As explained further below, the method includes steps and cuts which enable this configuration in appearance while maintaining substantially the same strength and appearance as the square cut and while employing a single router bit for all such cuts.

Dimensionally, all cuts are made with a straight router bit having a diameter “Y” from a single sheet of substrate stock having a thickness “X” such that Y≦(½)X, and preferably (⅓)X. These ratios remain critical to the efficacy of the method herein. In the mortise, corners are given a rounding defined by Y and a length “L₁”. The tenon has a width substantially equal to L₁ and a height “Z”, such that Z>2X. On the item having the tenon, at each of the two opposing locations defined by the intersection of the tenon with the shoulder of the item from which the tenon is cut (and also defining a shoulder line from shoulder to shoulder), an additional undercut is given at a minimal, linear displacement sufficient to enable, upon joinder, the mated surfaces of the two items to appear in flush, contiguous, void-free abutment with minimal reduction in the strength of the join, as explained, shown and claimed herein.

The tenon further has a substantially rectangular peg-receiving aperture set at distance substantially equal to X from the shoulder line, and having a height “H”, such that H=X. A locking peg has a cross-section substantially conforming with the peg-receiving aperture. Rounding of the peg proximate to the undercuts is made with a rounder at a radial rounding substantially equal to (½)Y. The product of the method is also shown.

The mortise is a through mortise, meaning the aperture is entirely through the substrate. The tenon has a semicircular cross-sectional overall appearance, in accordance with a preferred embodiment of the subject invention. The mortise is substantially rectangular, but since it is cut with a circular bit, the edges are rounded in accordance with the radius of the bit. Thus, the tenon, as explained herein, is also rounded with a rounder to create an external surface that conforms with the internal surface of the mortise at the precise point where the mortise abuts the shoulder line, and the items are thereupon given a substantially flush appearance.

In the preferred embodiment of the subject invention, all cuts of the items are made from the substrate using a Computer Numerical Controlled Router (CNC Router) or similar device using a rotary cutting tool or bit of fixed dimension. The CNC Router is thus programmed to cut the items that together form the final assembly in accordance with patterns, intended to provide a kit of parts that assemble into the final design sought. For example, the invention is intended to provide a kit of parts all cut from the same substrate and in accordance with patterns, for construction of a house, furniture, and other related assemblies. Regardless of the final assembly, all items are connected with an identical mortise and tenon made in accordance with the inventive method disclosed and claimed herein. One of ordinary skill in the art will well recognize the ability to kit an assembly of a myriad of other, additional and/or different designs, in accordance with the teachings herein.

Key to the invention is the manner of cutting the mortise and tenon joints so that, when joined together they give an appearance substantially identical to that provided by straight perpendicular cuts, but without once changing the bit of the router or employing another cutting machine. Indeed, the only piece of equipment beyond the router and a single bit employed herein is a rounder for rounding certain edges of the tenon.

Observably, the tenon is peripherally semicircular in cross section. In order to permit a flush, sturdy connection between the mortise and tenon, the router is programmed to cut undercuts at a location formed by the semicircular extension of the tenon. The undercuts are formed as cutaways of a portion of the tenon shoulder such that the mortise will seat against the horizontal plane of the tenon, and eliminate any stress riser which can result in a crack or help break any sharply angled corner under load. The combined height of the undercut and the tenon shoulder immediately thereabove is equal to the thickness of the first material so as to avoid any gaps between the first material and the tenon.

It should be appreciated that, by design, each kit of parts created in accordance with the invention further includes a tool which is also created from the same substrate and in the same manner by the router in accordance with a programmed pattern. This also becomes the only tool necessary to complete any assembly and is generally intended to be included with each kit of parts. It is understood that forming the hammer from the same material that is used to form the first material and the second material assures that the hammer and the mortise and tenon joint will have the same relative size, thickness, hardness and specific density such that the hammer will not mark or dent the components of the mortise and tenon joint during assembly. The hammer head includes two striking surfaces at either end. In another preferred embodiment of the instant invention, at least one of the two striking surfaces is rounded to prevent damage to the components of the mortise and tenon joint during the assembly thereof. Further, the hammer may include rounded shoulders or corners, also to prevent damage to the components of the mortise and tenon joint during the assembly thereof.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is an environmental view of one embodiment of the present invention, showing two members joined to one another;

FIG. 2 is an environmental view of one embodiment of the present invention, showing two members to be joined to one another;

FIG. 3 is a top view of one member having a mortise cut therein, in accordance with a preferred embodiment of the present invention;

FIG. 4 is a perspective side view of one member having a tenon at the distal end thereof in accordance with a preferred embodiment of the present invention;

FIG. 5 is an environmental view of a locking peg utilized to secure the mortise and tenon joint once the tenon is inserted into the mortise, in accordance with a preferred embodiment of the present invention;

FIG. 6 is an environmental view of the tool used to assemble the mortise and tenon joint, in accordance with one embodiment of the present invention;

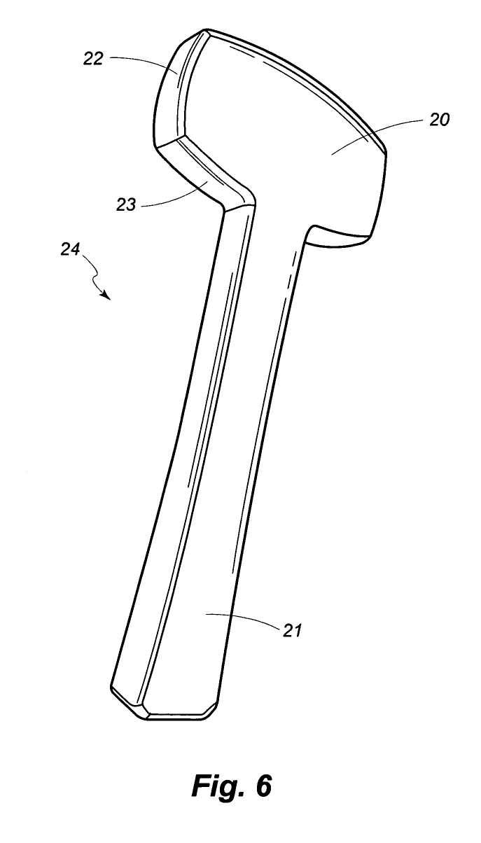

FIG. 7 is a flow diagram showing the steps employed while using a CNC router for creating a kit of parts for shipping, in accordance with another embodiment of the present invention; and

FIG. 8 is a cross-sectional view along line I-I in FIG. 1.

### DETAILED DESCRIPTION OF THE PREFERRED EMBODIMENTS

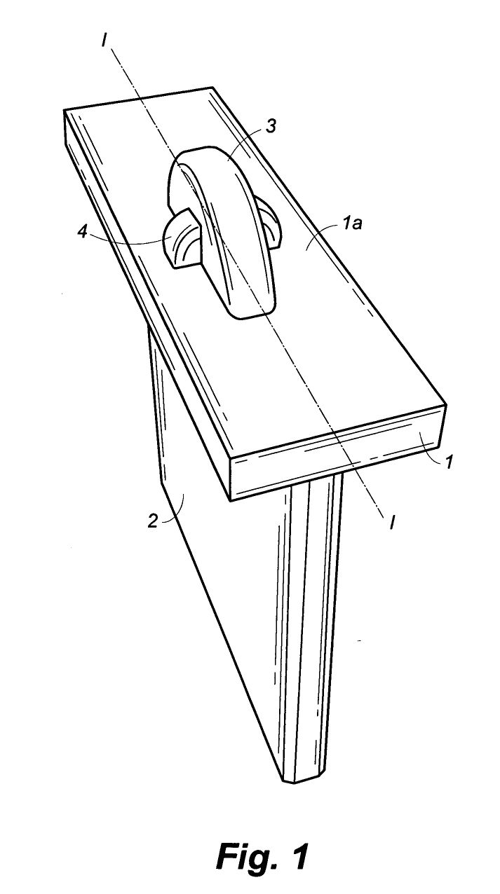

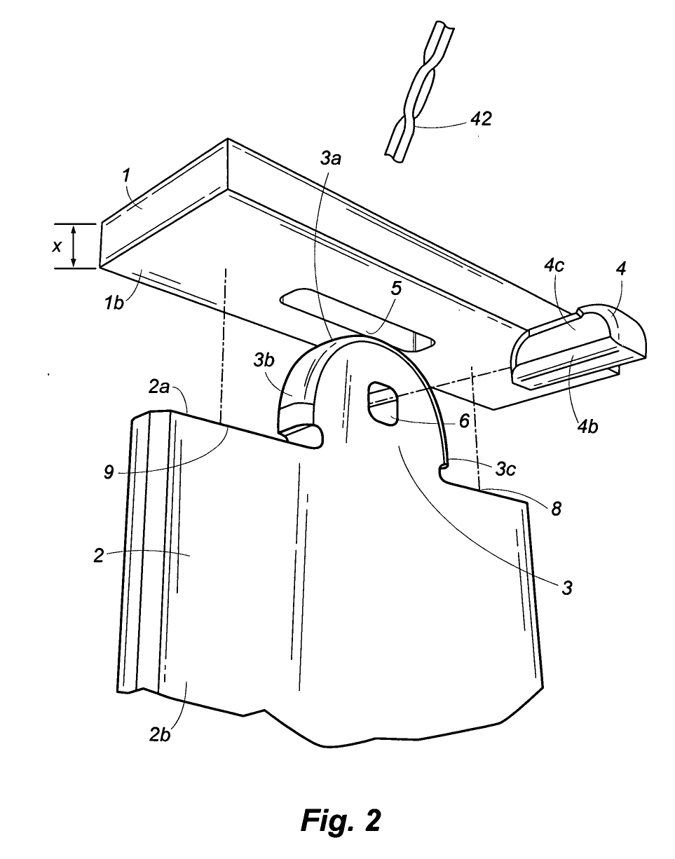

In accordance with the subject invention, FIG. 1 shows one embodiment of the present invention in which the mortise and tenon joint of the instant invention are shown in assembled form, such that two members are joined together. In particular, first member 1 includes a top 1a and bottom 1b (shown in FIG. 2). Second member 2 includes tenon 3 at the top of second member 2, such that tenon 3 extends upwardly through the bottom of first member 1 through an aperture (or mortise) in first member 1. Locking peg 4 is then inserted horizontally through an aperture (or mortise) in the top portion of tenon 3.

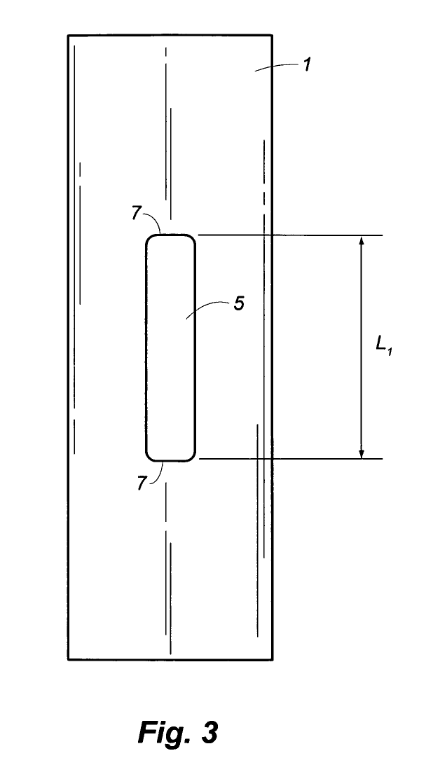

As shown in FIGS. 2-3, mortise 5 is shown as the preferred rectilinear configuration through member 1, such that mortise 5 extends through top 1a (as shown in FIG. 1) and bottom 1b of first member 1 forming an aperture that comprises the mortise. It should be appreciated that all cuts shown, save the rounding of the surfaces of tenon 3, are created by the same bit 42.

Second member 2 includes top 2a and bottom 2b. As shown in FIG. 2, top 2a of second member 2 runs horizontally from first lateral shoulder 8 to second lateral shoulder 9 in a straight shoulder line.

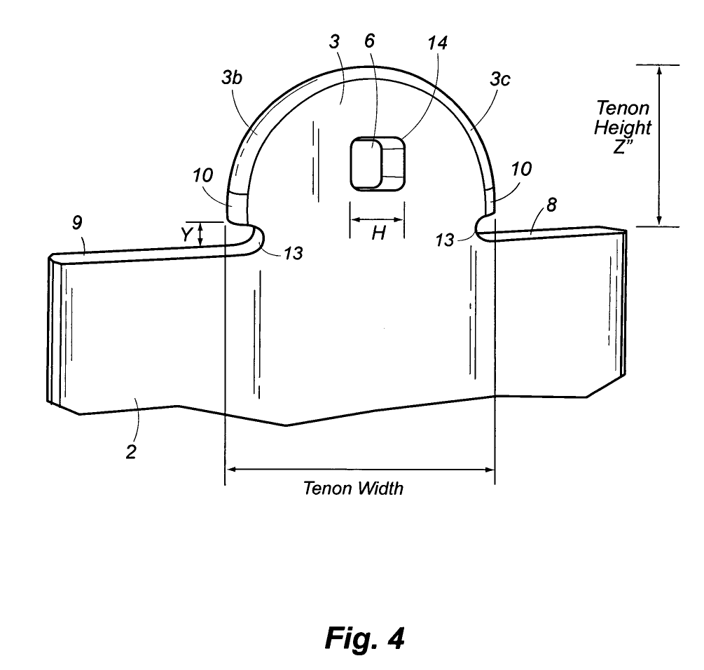

Second member 2 also includes tenon 3 within top portion 2a of second member 2. Tenon 3 includes distal end 3a, left side 3b and right side 3c. Tenon 3 protrudes from top 2a of second member 2, and corresponds in size and shape to mortise 5 such that tenon 3 fits within first mortise 5. In a preferred embodiment of the instant invention, left side 3b and right side 3c of tenon 3 each have at least one vertical shoulder 10 on either side of distal end 3a of tenon 3 (see FIG. 4), which snugly abut the interior conforming walls of mortise 5 when the mortise and tenon are assembled.

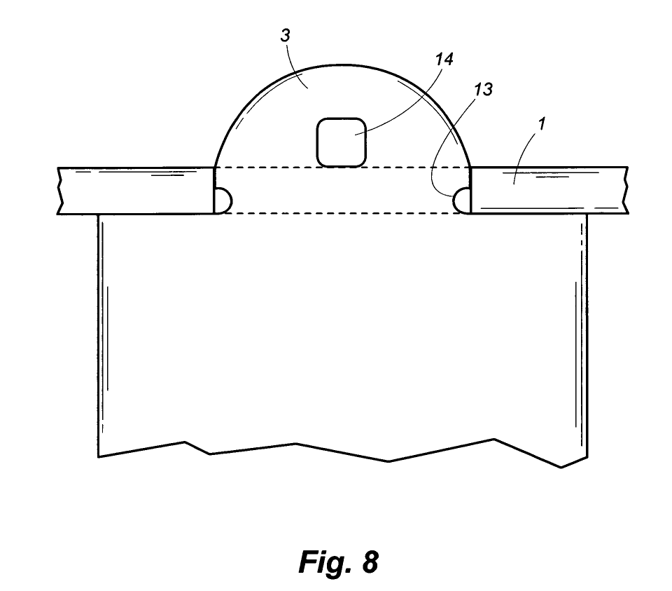

As further shown in FIG. 4, mortise 2 contains peg-receiving aperture 6 having an internal conformation 14 created by bit 42, and having height “H.” Critically, where the cross-sectionally semicircular tenon 3 would meet the shoulder line created by the extension of surfaces 8 and 9, undercuts or indents 13 are provided by bit 42 a minimum distance inwardly sufficient to permit the tight, seamless interlocking of the join when assembled, but not at a distance that would create a peril to the strength of the joint. Tenon 3, as shown, comprises indents or undercuts 13 on left side 3b and right side 3c of tenon 3, such that the bottom of each indent 13 is parallel to top 2a of second member 2, upon assembly. It should be appreciated, that in the absence of undercuts 13, upon assembly of the joint, flush fitting between mortise and tenon would be prevented as the internal configuration of walls 5, containing rounded corners 7 (having a radial dimension identical to bit 42, as these walls are created by that bit) would prevent the same. In the presence of undercuts 13, and with the additional use of a rounder upon vertical shoulders 10, the external conformation of shoulders 10 now meets the internal conformation of rounded corners 7, rendering a near perfect fit, and the absence of any continuing edge is provided by the presence of undercuts 13, as shown. The solution as shown provides for rapid CNC router programming and cutting with the same bit, while providing an appropriately strong and fitting joint assembly. Moreover, while there are voids present upon assembly of the joint as a result of the inclusion of undercuts 13 (see FIG. 8), as shown in the assembled form of FIG. 1, such voids are not visible.

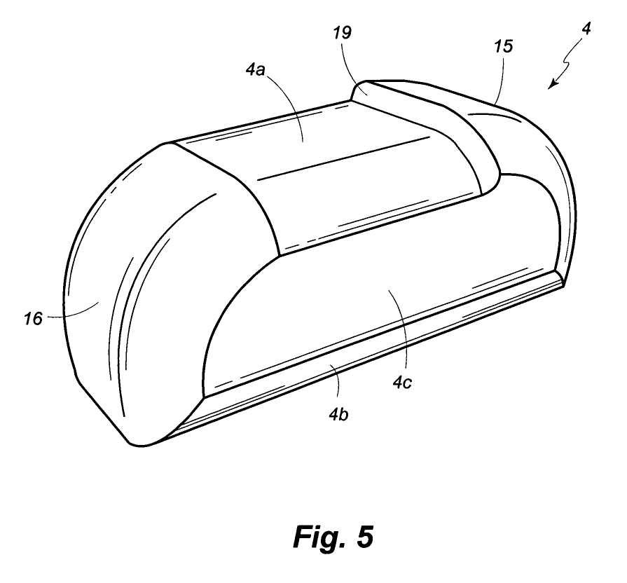

Likewise, as shown in FIG. 4, peg-receiving aperture 6 contains internal rounded wall surfaces 14 which are as well created by and dimensionally commensurate with bit 42. The internal conformation of aperture 6 is such to permit, as shown in FIG. 5, cooperative engagement of locking peg 4, by providing configuration in size and shape conforming with the size and shape of aperture 6 such that locking peg 4 fits snugly within aperture 6, as shown in FIG. 1. Locking peg 4 comprises top portion 4a, bottom portion 4b, at least two side portions 4c, distal end 15, and proximal end 16. In one particular embodiment of the instant invention, distal end 15 and proximal end 16 of locking peg 4 are both rounded, to facilitate snug insertion of locking peg 4 into aperture 6. In a preferred embodiment of the instant invention, shown in FIG. 5, top portion 4a of locking peg 4 includes notch 19 to control how far locking peg or pin 4 may be inserted into aperture 6.

In one particular embodiment of the instant invention, hammer 24 is cut from the same stock material as first member 1, second member 2, tenon 3 and locking peg 4. Hammer 24 may be used to aid in inserting tenon 3 through mortise 5 and inserting locking pin or peg 4 into mortise 6. It is understood by one of ordinary skill in the art that forming hammer 24 from the same material that is used to form first material 1 and second material 2 assures that hammer 24 will have the same relative size, thickness, hardness and specific gravity such that hammer 24 will not mark or dent the components of the mortise and tenon joint during assembly. Moreover, this provides a complete kitting of parts, and optimizes the use of materials with minimal waste in the process of creation of that kit and patterns to be cut from sheets of material.

The substrate or stock material may include any material used in the fields of carpentry, masonry, or metal work, such as wood, plastic, metals, synthetic materials, composites, moisture resistant medium density fiberboard, exterior medium density fiberboard and other building materials. In a preferred embodiment of the instant invention, the stock material is a medium density fiberboard. More specifically and critically, regardless of material, the combined height of vertical shoulder 10 and undercut 13 equals the thickness of the stock material, regardless of the material used.

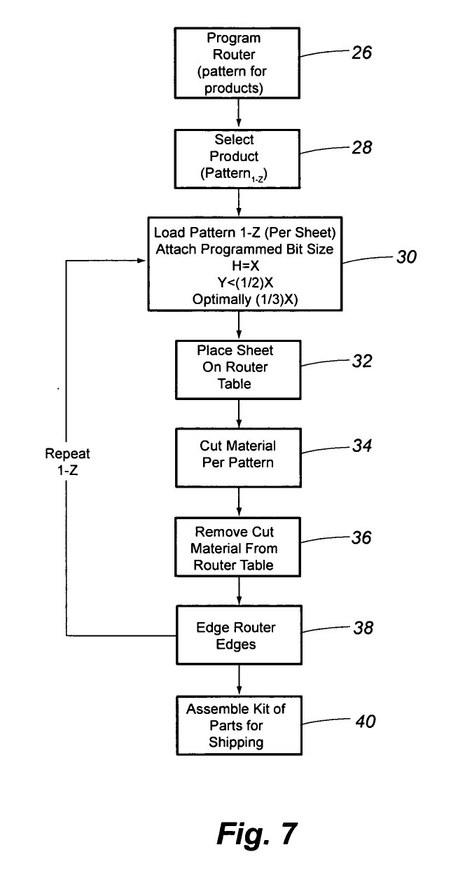

As shown in FIG. 7, an entire kit of parts can be programmed at step 26, to permit sections of a product at step 28, having pattern(s) 1-Z. Once the product for which the kit of parts is sought is selected, the flow identifies the steps of loading the pattern (1-Z), maintaining the bit size as shown, placing a sheet of substrate material on router table at step 32, cutting material per pattern as step 34, removing the cut material from the router table at step 36, using an edge router or rounder at step 38, and, upon repeating steps 30-38 Z times, assembling kit of parts for shipping at step 40.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A method for making two joinable items each having a mating surface visible upon joinder, such that upon joinder of the items, the mated surfaces appear to be in substantially flush, contiguous, void-free abutment, comprising the steps of:
(a) cutting each item with a straight router bit having a diameter “Y” from a single sheet of substrate stock having a thickness “X” such that:
Y≦(½)X;
(b) said cutting of each item including:
(1) on one item, a substantially rectilinear mortise with corners having a rounding defined by Y and a length “L₁”;
(2) on the second item, a tenon having a width substantially equal to L₁ and a height “Z”, such that
Z>2X;
(3) on the second item, at each of the two opposing locations defined by the intersection of the tenon with the shoulder of the second item from which the tenon is cut (and also defining a shoulder line from shoulder to shoulder), an additional undercut at a minimal, linear displacement sufficient to enable, upon joinder, the mated surfaces of the two items to appear in flush, contiguous, void-free abutment with minimal reduction in the strength of the joint;
(4) on the second item, in the tenon, a substantially rectangular peg-receiving aperture set at distance substantially equal to X from the shoulder line, and having a height “H”, such that:
H=X;
(c) additionally cutting a locking peg having a cross-section substantially conforming with the peg-receiving aperture with the same router bit from said single sheet of substrate; and
(d) rounding with a shaper the edges of said peg proximate to said undercuts at a radial rounding substantially equal to (½)Y.

2. The method of claim 1, wherein said router is a computer numerical controlled router.

3. The method of claim 1, wherein said cutting of said locking peg further comprises a notch of sufficient geometrical proportion to enable the control of the extent of insertion of the locking pin into the peg-receiving aperture.

4. The method of claim 1, further comprising the step of cutting a hammer means from said stock of sufficient size to enable the assembly of the mortise and tendon joint and locking peg.

5. The mortise and tendon joint assembly produced in accordance with the method of claim 1.
